(19) United States
(12) Patent Application Publication
(10) Pub. No.: US 2025/0047693 A1
(43) Pub. Date: Feb. 6, 2025

(54) SYSTEMS AND METHODS FOR MACHINE LEARNING BASED NETWORK ALERT SEQUENCE ANOMALY DETECTION

(71) Applicant: HSBC Group Management Services Limited, London (GB)

(72) Inventors: Bojan Kolosnjaji, London (GB); Philip Intallura, Chicago, IL (US); Huang Xiao, London (GB)

(21) Appl. No.: 18/920,342

(22) Filed: Oct. 18, 2024

(30) Foreign Application Priority Data
Oct. 13, 2023 (GB) 2315747.2

(51) Int. Cl. H04L 9/40

(52) U.S. Cl. CPC H04L 63/1416; H04L 63/1425

(57) ABSTRACT

A method of processing network security alerts includes receiving a plurality of security alerts generated by network security devices in a network, each security alert comprising alert data relating to the security alert and specifying an alert time and a network device, a user identity associated with the security alert, or both. A group of related alerts are selected from the plurality of security alerts, the group of related alerts having an alert time within a given time window and associated with one or both of: a given network device; and a given user identity. Alert data for the selected alerts is provided as an input data set for a machine learning model configured to generate an anomaly score. An action is then performed in dependence on the anomaly score.

### FIELD OF THE INVENTION

The present application relates to computer-implemented method of processing network security alerts.

### BACKGROUND OF THE INVENTION

Information Technology (IT) infrastructures, such as computer/communications networks, implement various technologies for detecting and responding to possible security threats. For example, firewalls, routers, storage servers, application servers and other hardware/software components in a network may perform intrusion detection (e.g. detecting attempted access by unauthorised devices), malware/virus detection, detection of suspicious traffic patterns such as denial-of-service attacks, and the like.

Many existing systems generate risk-based alerts, which are low-confidence indicators of potentially malicious behaviour on specific devices or user accounts. Alone, such alerts may not reliably indicate whether malicious behaviour has occurred or is occurring, requiring laborious and error-prone manual analysis of alert logs by technical specialists. This is made even more challenging by the sheer scale and complexity of modern IT infrastructures, which may generate large volumes of alert data of this type. However, to ensure network security and prevent malicious activity from causing damage, fast and accurate detection is needed. While existing alert logs might allow after-the-fact analysis of past security events, the limitations of existing systems often prevent reliable and timely intervention.

In order to address those limitations, embodiments of the invention provide a system based on Artificial Intelligence and Machine Learning, in particular Active Learning, to increase automation and more accurately detect and prevent malicious activity.

### SUMMARY OF THE INVENTION

Aspects of the invention are set out in the independent claims and preferable features are set out in the dependent claims.

There is described herein a computer-implemented method of processing network security alerts, comprising:
receiving a plurality of security alerts generated by network security devices in a network, each security alert comprising alert data relating to the security alert, the alert data specifying an alert time and one or both of: a network device and a user identity associated with the security alert;
selecting from the plurality of security alerts a group of related alerts, the group of related alerts having an alert time within a given time window and associated with one or both of: a given network device; and a given user identity;
generating, based on alert data of the selected alerts, an input data set for a machine learning model, the machine learning model configured to generate an anomaly score in dependence on the input data set;
inputting the input data set to the machine learning model to obtain the anomaly score for the input data set; and
performing an action in dependence on the anomaly score.

By grouping alerts in time windows and/or according to device and/or user, alerts can be analysed in context, allowing more accurate assessment of security risks. The output anomaly score generated by the model can be considered an indicator of whether alerts are associated with a low security risk (non-anomalous behaviour, low anomaly score) or a high security risk (anomalous behaviour, high anomaly score). The anomaly score may be a numerical score in a defined range, or in other embodiments may be an anomaly classification.

Preferably, the method comprises generating a plurality of alert groups associated with the given network device and/or given user identity based on respective time windows and applying the machine learning model to input data sets generated for each alert group. The grouping may be performed based on a moving time window, e.g. to generate successive alert groups.

The input data set generated for the alert group preferably comprises a sequence of alert records corresponding to a sequence of security alerts having alert times within the given time window and associated with the given network device and/or the given user identity. Thus, the model is preferably applied to groups or sequences of alerts rather than individual alerts, and produces an anomaly score for an alert group or sequence. Each alert record in a group preferably comprises one or more alert attributes for a respective one of the security alerts of the group, the alert attributes based on the alert data.

The method may additionally augment alert records with context data. The method may comprise, for one or more (or each) of the security alerts in the group, obtaining context data relating to each alert from one or more context data sources and adding the context data to the corresponding alert record. The context data sources may comprise one or more of: user data, device data, software service data, and user authorisation data. The method may comprise adding a plurality of context attributes to each alert record, preferably based on context data from a plurality of context data sources. Thus, context-enhanced alert records may be generated that include alert attributes from the original network alerts together with various context attributes. Note the terms “attributes”, “properties” and “features” are generally used interchangeably herein.

Security alerts may be associated with network events detected in the network, and the context data for a security alert associated with a given network event may include data relating to one or more of: a user identity associated with the event; a network device involved in the event; a software service or application involved in the event; a user authorisation of a user associated with the event, optionally comprising one or more of: a service authorisation and a device authorisation associated with the event.

Alert records (or more particularly, context-enhanced alert records) may be vectorised for processing by the machine learning model. The method may comprise converting alert records including alert attributes and/or context attributes into a numerical input representation for input to the machine learning model, the conversion optionally comprising one or both of: normalising one or more numerical attributes to a predetermined range, optionally a range of zero to one; and/or encoding one or more categorical attributes using a binary encoding, optionally a one-hot encoding.

The method may comprise: identifying, for a given security alert, a network device to which the security alert relates, wherein a network device is preferably a network device at which a network event or operation that caused the security alert occurred or was performed; retrieving from a context data source device data relating to the identified network device; generating one or more device context attributes based on the device data; and including the one or more device context attributes in the alert record for the security alert.

The method may alternatively or additionally comprise: identifying, for a given security alert, a software service to which the security alert relates, wherein the software service is preferably a software service at which an event or operation that caused the security alert occurred or was performed; retrieving from a context data source software service data relating to the identified network device; generating one or more software service context attributes based on the software service data; and including the one or more software service context attributes in the alert record for the security alert.

The method may alternatively or additionally comprise: identifying, for a given security alert, a user identity of a user to which the security alert relates; retrieving from a context data source user data relating to the identified user identity; generating one or more user context attributes based on the user data; and including the one or more user context attributes in the alert record for the security alert.

The method may alternatively or additionally comprise: identifying, for a given security alert, a user identity of a user to which the security alert relates; retrieving from a context data source authorisation data relating to the identified user identity; generating one or more authorisation context attributes based on the authorisation data; and including the one or more authorisation context attributes in the alert record for the security alert. The authorisation data may specify authorisations of users in relation to access to one or both of: network devices; and software services or applications. The authorisation context attributes may specify authorisation information relating to the identified user and to one or more of: a network device, and a software service for which the identified user has been authorised (and/or to which the alert relates).

The security alert may correspond to detection of a network operation, wherein the user to which the security alert relates is a user initiating or performing the operation.

Preferably, the machine learning model comprises a neural network. In particular examples, the machine learning model comprises a recurrent neural network (RNN), preferably a long short-term memory (LSTM)-based network, adapted to process alert records for the group of alerts in sequence and to generate and output an anomaly score based on the alert records of the group.

The network may include at least one layer of LSTM neurons. In an embodiment, the network may comprise: an embedding layer adapted to perform dimensionality reduction for alert records comprising a plurality of alert and/or context attributes, and an LSTM (or other recurrent/feedback) layer adapted to operate on the output of the embedding layer. The network may further comprise one or more further layers for generating the anomaly score based on the output of the LSTM layer, the further layers optionally including an average pooling layer and/or a scaling layer adapted to scale an output of the model to a predetermined range, the scaling layer optionally comprising a sigmoid layer.

Preferably, the method comprises training the machine learning model based on a training data set, the training data set comprising groups of security alerts augmented with context data and associated with training labels. The training labels may define an expected anomaly score output of the model and may be obtained based on one or more of: user labelling of training samples; and label propagation from previously labelled training samples.

The method may comprise retraining the model in dependence on one or more retraining trigger conditions, the retraining trigger conditions comprising one or more of: reception of one or more security alerts; one or more performance metrics relating to performance of the model; user feedback, optionally to relabel one or more alert groups; and a retraining schedule.

The method preferably comprises outputting the anomaly score computed by the model for the alert group to a user. The method may comprise receiving an anomaly label, optionally an anomaly score (or modified anomaly score), from the user for the alert group, storing the anomaly group with the assigned anomaly label as a training sample, and using the training sample in a subsequent retraining of the machine learning model.

More generally, the method may comprise identifying one or more training samples for labelling by an operator, receiving via an application interface training labels for the training samples from the operator, and using the training samples and training labels to train or retrain the machine learning model. Training samples comprise sequences of alert records (or context-enhanced alert records) generated and/or vectorized as set out above and described in more detail later.

Identifying one or more training samples may comprise identifying one or more of: one or more training samples in a region of the machine learning model input feature space associated with model outputs that meet relabeling or uncertainty criteria, for example falling in a predetermined uncertainty range; one or more training samples in a region of the input feature space that is sparsely populated with labelled training samples (e.g. based on a density measure applied to the labelled points in the feature space); and one or more training samples relabelled by the operator via the application interface.

The method may comprise comparing the anomaly score to one or more thresholds or ranges and selecting an action in dependence on the comparison. In an example, the method comprises: in response to the anomaly score meeting a first threshold or falling in a first range, alerting a user; and/or in response to the anomaly score meeting a second threshold or falling in a second range, performing an automatic configuration action in the network to counter a security risk associated with the group of alerts. The method may also comprise, in response to the anomaly score output by the model falling within a determined range, prompting a user to review the alerts of the alert group and assign an anomaly score.

The action(s) performed based on the anomaly score may comprises one or more of: alerting an operator to a detected anomaly; modifying a configuration of, disabling, or quarantining a device associated with the group of security alerts; modifying a device configuration in the network (e.g. of a security or traffic management device) to control, shape or block traffic associated with a user, device or software service to which security alerts of the group relate; and modifying one or more user authorisations, for example to disable a user account or user access to a device or software service.

Also disclosed is a system having means, optionally comprising one or more processors and associated memory, for performing any method as set out herein. The disclosure further encompasses a computer program, computer program product or non-transient computer readable medium comprising software code adapted, when executed by a data processing system, to perform any method as described herein.

Any feature in one aspect of the invention may be applied to other aspects of the invention, in any appropriate combination. In particular, method aspects may be applied to system or computer program aspects, and vice versa. Features described as implemented in software may also be implemented in hardware (and vice versa).

### BRIEF DESCRIPTION OF THE FIGURES

Certain embodiments of the invention will now be described by way of example only, in relation to the Figures, wherein:

FIG. 1 illustrates a system for processing network security alerts in overview;

FIG. 2 illustrates a process for analysing network security alerts using a machine learning model;

FIG. 3 illustrates a method for enhancing alert records using context data;

FIG. 4 illustrates a method for encoding alert data and context data;

FIGS. 5A-5F illustrate example data tables for storing alert and context data;

FIG. 6 illustrates a context-enhanced alert record;

FIG. 7 illustrates a design of a machine learning model for assigning anomaly scores to alert sequences;

FIG. 8 illustrates a method for model training;

FIG. 9 illustrates a system architecture of an alert processing system;

FIG. 10 illustrates a workflow for analysing alert data;

FIG. 11 illustrates a relationship between a machine learning model and operator feedback using an active learning approach;

FIG. 12 illustrates a process of model retraining using an active learning approach;

FIGS. 13A-13B show an example data model for storing alert, context and model data; and

FIG. 14 illustrates a computer device for performing described data processing tasks.

### DETAILED DESCRIPTION

Embodiments of the invention provide a system for processing network security alerts (also referred to herein as “risk-based-alerts”). The system enables generation of high confidence alerts by combining low confidence alerts with additional context data pertaining to the alerts.

Risk-based alerts are low-confidence indicators of potentially malicious behaviour on specific machines or user accounts. The described system uses machine learning methodologies and models to automate the detection, identification, and classification of unauthorized or abnormal network activities through the analysis of low-confidence alerts, aided by feedback from an expert using the results of this automated process. The described machine learning approaches are capable of performing their analysis without explicit external rules defined on the normal operations of the network, allowing for the system to dynamically and automatically adjust to normal changes in the network operations. Feedback from an expert can additionally be used to steer this analysis and supervise model performance to improve the accuracy of the model.

Detection of abnormal behaviour is used as a basis to improve the health of the network by, for example:
Quarantining machines that generate malicious behaviour
Changing network traffic rules to impede this behaviour
Locking accounts that are determined to be the source of this behaviour
Accelerating the work of the Security Operation Centre (SOC), providing real-time high confidence alert generation and reduce personnel involvement in triage of security alerts, so personnel can focus on resolving high confidence alerts.

Described approaches can enable improved efficiency and operation of the network and reduction of cybersecurity risk. Incidents can be identified based upon the detected unauthorized or abnormal behaviour. Suspect devices can be quarantined more quickly and collateral damage from undetected or slow reaction incidents can be reduced.

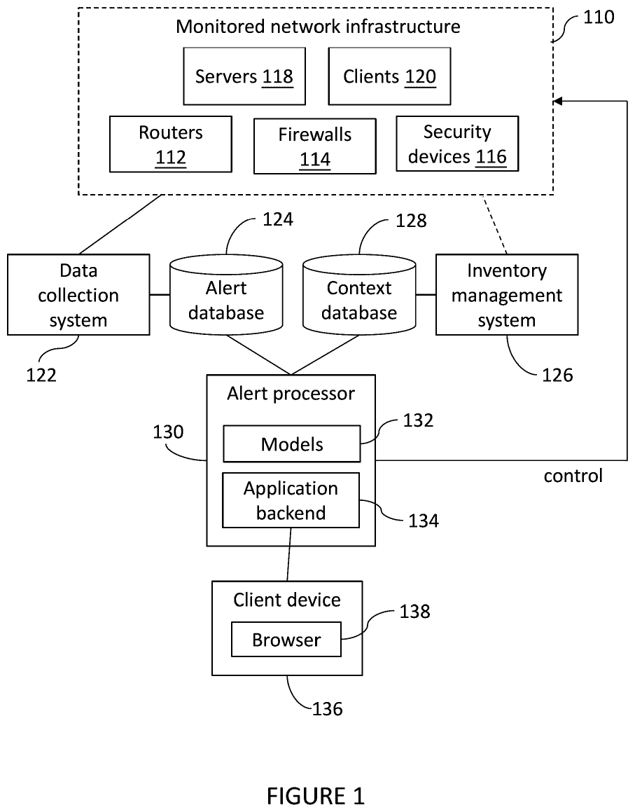

FIG. 1 shows an alert processing system in overview. The alert processing system includes a monitored network infrastructure 110 including various devices, for example server devices 118 and client devices 120, along with network infrastructure devices such as routers 112, firewalls 114 and other security devices 116. Note the various device types are shown by way of example and other types of devices may be connected to the network infrastructure.

Security devices could include, for example, traffic monitors and vulnerability scanners. Note that security functions may be implemented by specialised devices/network nodes, or by security agents executing on other devices. For example, server, client and router devices may include software agents performing firewall, malware scanning, vulnerability scanning, traffic monitoring and other security functions. Any such security components (whether implemented as standalone devices or software agents) may generate network security alerts, which may be logged locally and/or transmitted to a remote system.

A data collection system 122 collects alert data from the devices in the monitored network infrastructure. The data collection system may retrieve alert data (e.g. logs) directly from the various devices 112-120 and/or from one or more security controllers (not shown). Devices and security controllers may also push alert data to the data collection system when it is generated, e.g. as soon as alerts are generated or in batches. The alert data for the security alerts is stored in an alert database 124.

The system also includes one or more context databases 128 storing network inventory information about entities in the monitored network infrastructure. The context database may include data about network devices (112-120), software entities and services (e.g. applications/services deployed in the infrastructure, virtual machines etc.) and other entities provided by or interacting with the network infrastructure (e.g. users/user accounts, user authorisations etc.) and any other related information. The context database may be maintained by an inventory management system 126, which may obtain relevant information directly from the network infrastructure 110 and its devices, from other inventory databases/sources, via direct user input from network administrators, etc.

An alert processor 130 accesses alert data in the alert database 124 and inventory information in the context database(s) 128 and uses this information to train and apply machine learning models 132. The machine learning models analyse alerts generated by the network infrastructure, which are generally associated with low confidence, to generate high confidence alerts that provide information on possible network anomalies or security risks. The processed alerts are made available for viewing and analysis through a visualisation application. For example, this may involve a server application backend (134) for a web application, accessed via a browser 138 on a client device 136. However, alternatively, a native client application interacting with the application backend, or performing all processing locally at the client device based on data retrieved from the alert processor, could also be provided.

The application, accessed by an operator using the client device, allows the user to view and analyse generated high-confidence alerts, reclassify alerts, and control re-training of models 132, as described in more detail below.

The alert processor and/or application may additionally interact with the managed network infrastructure 110 and its devices to control devices, for example to perform configuration actions in response to detected anomalies and security risks.

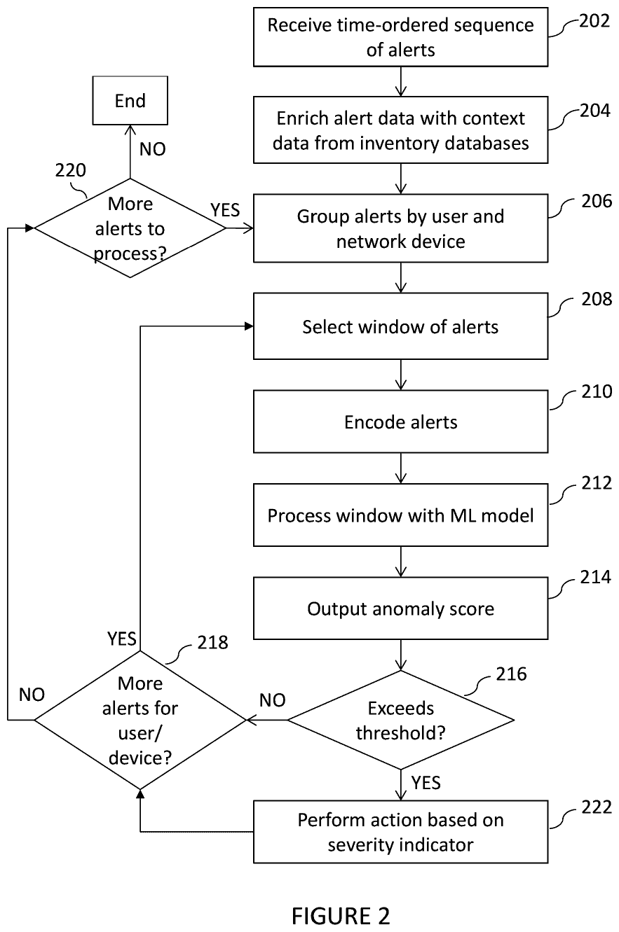

FIG. 2 illustrates a process for analysing alert data with reference to the FIG. 1 system. The process may be performed by the alert processor 130.

The process starts with receipt of a time-ordered sequence of network security alerts in step 202. This may be obtained by the data collection system 122 from the devices in the network as described above and stored in the alert database. Each alert is associated with an alert time (e.g. a timestamp) specifying a relevant time for the alert, for example the time the alert was generated by an alert generator and/or the time of an event which caused the alert to be generated. In an embodiment, the alert processor retrieves alerts for a time period to be analysed (e.g. a day or a week) from the alert database.

Security alerts relate to events detected in the network that are flagged by security devices as representing a possible security risk (e.g. attempted, failed or successful access to a particular resource, login attempts, invocation of certain functions or operations at a device or software service, transmission of data packets with certain sources and/or destination or matching certain patterns etc.) Security alerts are associated with information about users and/or network devices associated with the alerts. For example, a particular security alert may specify:
A user identity of a user/user account involved in a network event that gave rise to the security alert. For example, this may be a user or account performing (or attempting to perform) an operation, or a user that is the subject of an operation, or that is otherwise associated with a network operation or event that triggered the security alert. The user identity may, for example, be a username, email address, or other account or user identifier.
A network device where a network event occurred or where an operation was performed (or attempted to be performed) that gave rise to the security alert. The network device may be identified by any suitable device identifier (e.g. a hostname, MAC address, IP address etc.) The alert data for an alert typically includes other information describing the alert that is generated by the security device that created the alert. In an embodiment, this includes a classification of the security alert in accordance with the MITRE ATT&CK® threat classification model Alert data may include some or all of the following alert attributes:
A risk score—a numerical value quantifying the risk associated with the alert (e.g. on a 0-20 scale).
Event description—a description of the event that caused the alert. This may be one of a fixed set of event descriptions detectable by the security device(s).
MITRE Attack tactic—identification of a particular attack tactic associated with the event in accordance with the MITRE threat model
MITRE Attack technique—identification of a particular attack technique in accordance with the MITRE threat model
Severity—a severity classification, e.g. “low”, “medium” or “high”.

While in the example the alerts are classified according to the MITRE threat model, other threat models could be used.

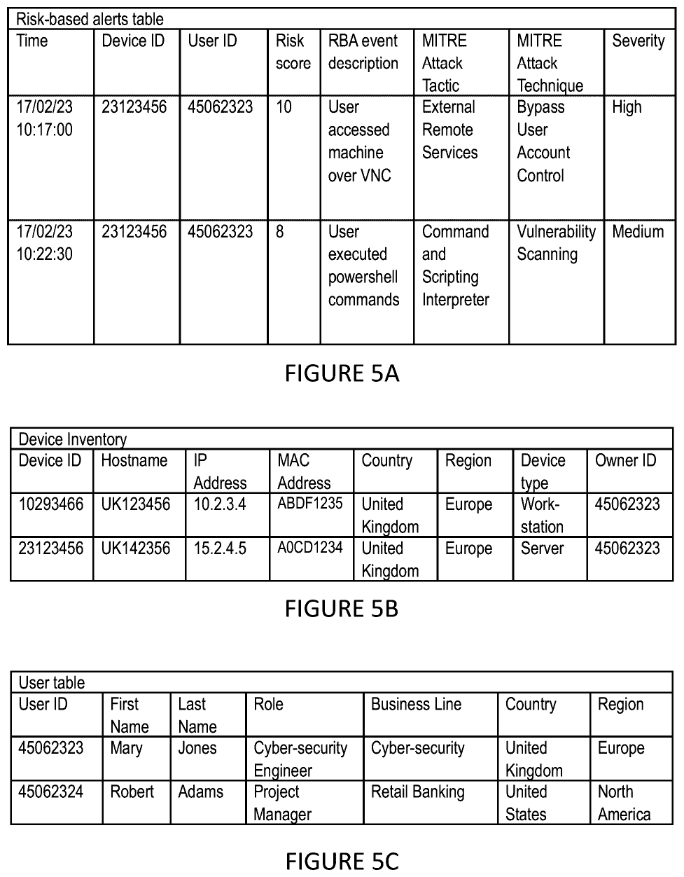

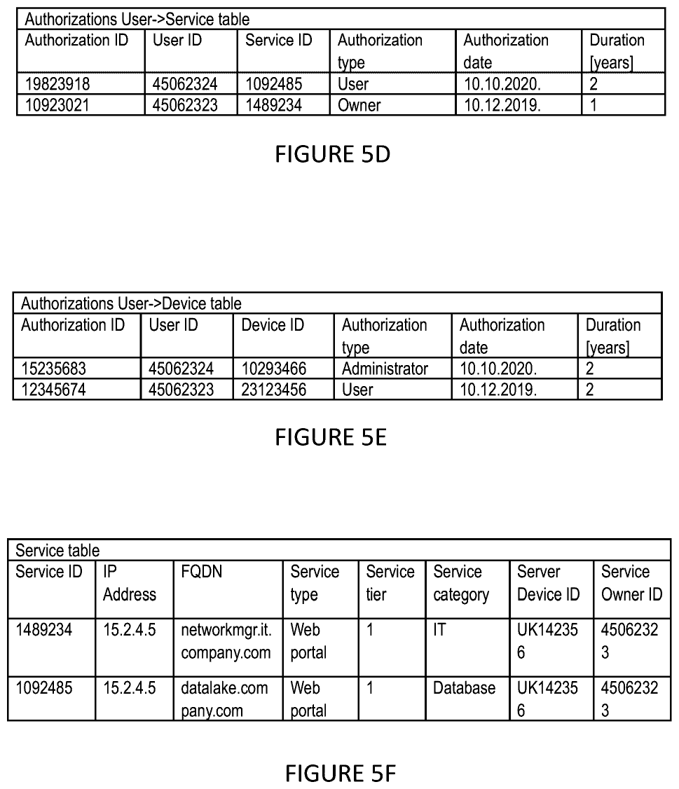

An example of an alert table for storing alert records in the alert database 124 and including various alert attributes is shown in FIG. 5A.

In step 204 the alert data for the security alerts is enriched with context data obtained from the context database 128. This step is described in more detail below.

In step 206, the system groups alerts by user identity and network device. Specifically, the system selects a subset of the alerts specifying the same user identity and network device, for a given combination of user identity and network device.

In step 208, the system then selects a group of alerts for that user identity and network device that fall within a particular time window. For example, the system could select alerts within a window of an hour or a day. If there are no alerts within the time window, the time window is skipped. This results in a group of one or more alerts for the user and device combination within the specified time window.

In step 210, the context-enriched alert data for the selected group of alerts, arranged as a sequence in alert time order, is encoded into an input data set for a machine learning model. This involves vectorizing the context-enhanced alert records, i.e. converting the alert and associated context data into a consistent numerical form that can be processed by the model, as will be described in more detail below. The encoded alert sequence is input to the machine learning model in step 212 and the model outputs an anomaly score corresponding that specific group of alerts in step 214.

In step 216, the system determines whether the anomaly score exceeds an anomaly threshold. If so, one or more actions are performed (step 222) in dependence on the value of the anomaly score. Once the relevant actions have been performed (or if no action is needed), the process continues to determine (step 218) whether there are more alerts to process for the given user/device combination. If yes, then the process continues to form the next window of alerts (step 208) for that user/device, and the above steps are repeated to analyse and process the next window of alerts. Once there are no more alerts for the particular user/device combination, then the process continues in step 220 to determine whether there are remaining alerts to be processed for other user/device combinations, repeating steps 208-224 to process alerts for a different user/device combination as needed. Note that the process can be performed selectively for specific users/devices, or the process may be repeated for all possible user/device combinations in the alert data. The process ends (step 220, NO branch) once all alerts for all possible or required user/device combinations have been analysed by the machine learning model.

Note that the FIG. 2 flow chart give an example of how the processing may be arranged. However, the order of steps may be altered. For example, the process could select all alerts within a given window first (step 208) in an outer loop and then group those alerts based on user/device for processing in an inner loop. As a further example, enrichment of alerts with context data (204) could be performed later, e.g. prior to encoding step 210. Alternatively, the encoding (vectorization) in step 210 could be performed after enrichment step 204, with the alerts stored in encoded form in the database and then subsequently retrieved for processing by the machine learning model. Steps could also be performed in parallel (e.g. to process data for different time windows or for different user/devices in parallel).

As a further variation, grouping of alerts (step 206) could be by device only or by user only rather than by specific <user, device> pairings. Other alert attributes could also be used additionally or alternatively to group alerts.

Instead of analysing the resulting anomaly scores and performing actions as they are generated (steps 216/222) the anomaly scores generated by the machine learning model may be stored in a database linked to the input alerts, and then processed later as required and thus analysis and actions resulting from the model outputs can be decoupled from the application of the model.

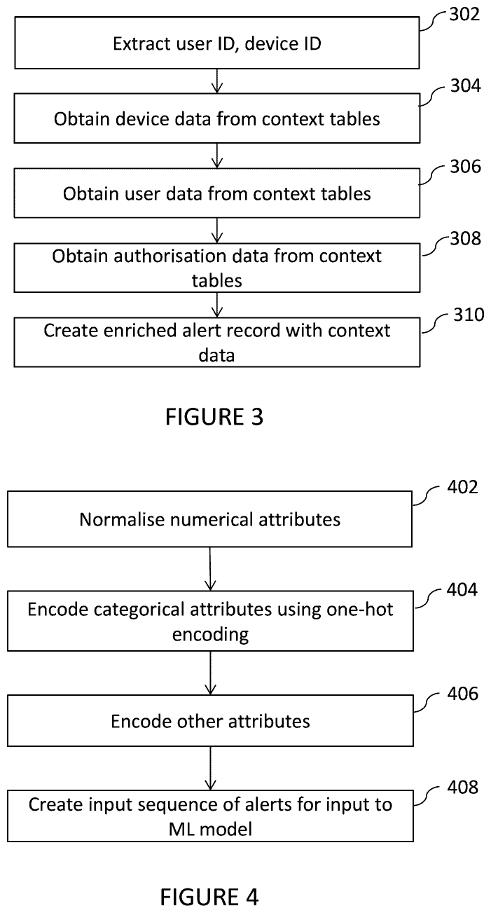

The step of enriching alert records based on context data (step 204) is illustrated in FIG. 3.

In step 302, the user identifier and device identifier are extracted from an alert record being processed. As described above and illustrated in FIG. 5A, the input alert records identify a user and device associated with the security alert, e.g. a user and device involved in an event or operation that triggered the security alert at a network security device.

In step 304, the device identifier is used to retrieve device information relating to the device from the context database. In an embodiment, the context database includes a set of context tables relating to devices, users, authorisations etc. as depicted in FIGS. 5B-5F. An example of a device inventory table provide device context information is shown in FIG. 5B. In this example the device attributes stored for each device include (in addition to the device identifier) a host name, IP address, MAC address, country and region where the device is installed, a device type (e.g. Workstation or Server) and an owner identifier (this may, for example, specify a user or department responsible for installation and/or management of the device). One or more of the device attributes for the device identified in the security alert are added to the enriched alert record as context attributes.

In step 306, the user identifier in the security alert is used to retrieve user information relating to the user from the context tables. An example of a user table providing user context information is shown in FIG. 5C. In this example, the user attributes stored for each user include (in addition to the user identifier) first and last names, role attributes (specifying the user's role in the organisation), a business line with which the user is associated, and a country and region where the user is employed. One or more user attributes for the user identified in the security alert are added to the enriched alert record as context attributes.

In step 308, the user identifier is additionally used to retrieve authorisation information relating to the user. In an embodiment, the context tables store two types of authorizations: service authorizations, and device authorizations. An example of a service authorisations table is shown in FIG. 5D. In this example, each authorization is identified by an authorization ID and the user ID of the authorized user. Additional attributes include a service ID identifying a service for which the user is authorized, an authorization type, an authorization date and an authorization duration. An example of a device authorization table is shown in FIG. 5E. In this example, each device authorization specifies an authorization ID and user ID of the authorized user. Additional attributes include the device identifier of the device for which the user is authorised, an authorization type, authorization date and authorization duration. Authorization data from the authorization tables is added to the context-enriched alert record based on the user identifier and/or device identifier specified by the security alert.

In an embodiment, the context tables further include a service table, providing additional information about the services identified in the service authorization table. An example is shown in FIG. 5F; in this example, service attributes include service ID, IP address where a service is deployed/accessed, a service domain name/URL/URI for the service, e.g. in the form of a Fully Qualified Domain Name (FQDN), a service type, service tier, service category, and identifiers of a server device where the service is deployed and a service owner.

Data from the authorization and service tables may used to create additional context attributes for the enhanced alert records as follows:
For a user ID identified in the security alert, additional context attributes may be obtained from the service authorization table (FIG. 5D) for a service authorization linked to the user ID
Additional context data attributes may be added to the data obtained from the service authorisation table based on the service table entry (FIG. 5F) for the authorised service identified in the service authorization table entry for the user
For a user ID and/or device ID identified in the security alert, additional context attributes may be added from the device authorization table (FIG. 5E) for a device authorization linked to the user ID and/or device ID
Where a software service (e.g. application) relating to a security alert can be identified (e.g. where a service identifier is provided as part of the alert data, or where the service can be otherwise inferred), service context attributes from the service table could also be added directly as additional context attributes

The above are merely examples, and other/additional approaches for deriving context attributes may be adopted (e.g. a device authorization for a user could be further linked to additional device attributes based on the device inventory).

Furthermore, other sources of context could be used in addition to/instead of some or all of the described sources. Examples of some possible other sources of features for augmenting the alert data may include: network traffic flow data, firewall logs, IDS/IPS logs, Antivirus/EDR logs, E-mail traffic logs. Additional context data sources can improve the efficiency of the system by reducing false positives and false negatives.

Context attributes can be derived by computing a table join between alert data and the context tables based on the user ID and/or device ID.

Returning to FIG. 3, in step 310, the various context attributes derived from the context tables are added to the security alert to create a context-enriched alert record. Note that the system may use only selected attributes from the context tables as context attributes (rather than necessarily all of the attributes shown in FIGS. 5B-5F). For example, the system might not use the first and last name of a user in the user table (5C) as context attributes as such information is unlikely to be useful for assigning an anomaly score by the model. Instead of using the context data directly, the system could also generate derived attributes based on the context table data (e.g. the system could generate a single location attribute from the “country” and “region” attributes of the device/user tables).

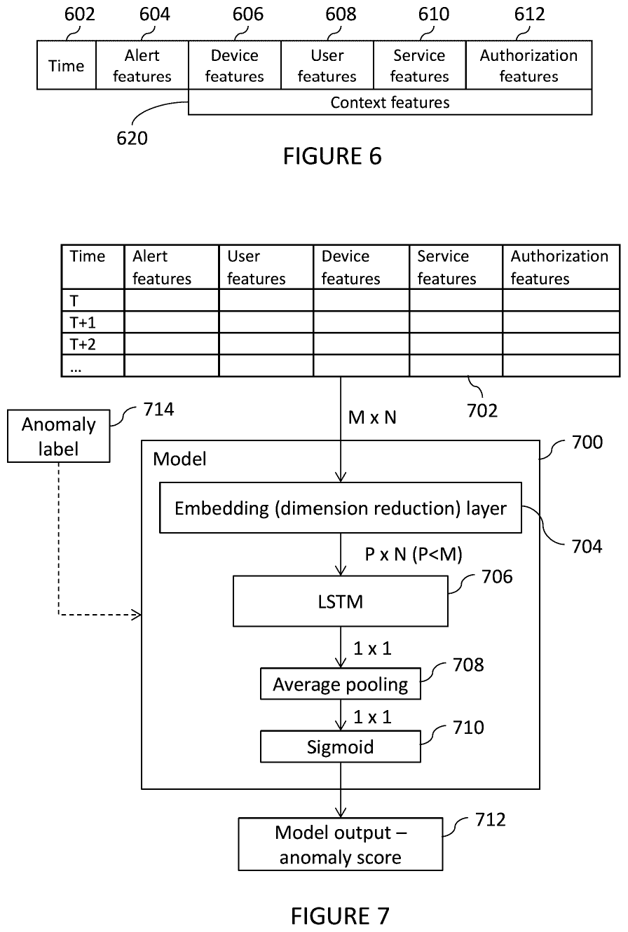

Step 310 results in a context-enhanced alert record. An example is shown schematically in FIG. 6. The enhanced alert record includes an alert time 602 and other alert features 604 derived from the security alert itself, along with context features 620 derived from the context attributes in the context tables. The context features 620 here include device features 606, user features 608, service features 610 and authorization features 612. However, the feature types (and specific features/attributes) used are given by way of example, and may be modified based on available information and requirements.

The FIG. 3 process is repeated for alert records in the input set to generate a set of context-enhanced alert records.

Returning to FIG. 2, the context-enhanced alert records are grouped by user and network device (step 206) and by alert time (208) to generate a sequence of alerts occurring within a particular time window relating to a specific combination of user and network device as previously described. The alert sequence is encoded to form an input sequence for the machine learning model. The encoding process is illustrated in FIG. 4.

The process involves applying different encodings to attributes of the enhanced alert records depending on the attribute type. For example, in step 402, numerical attributes are normalised to a predetermined range, typically 0 . . . 1. In step 404, categorical attributes (e.g. “region” or “device type” from the device inventory table) are encoded using a suitable binary encoding. In preferred embodiments, a one-hot encoding is used. This involves creating a bit vector of length equal to all the possible values of the categorical attribute. The feature vector assigns value “one” to the bit vector at the bit position equal to the index of the value in the possible value list for the categorical attribute. Other bits are set to zero (the bitmap may also be padded with zeros to align with a byte or word boundary).

If needed, other attribute types can be encoded in step 406 using any suitable encodings. For example, feature hashing could be used for certain types of attributes (e.g. strings).

The encoding process results in a vectorized representation of the enhanced alert record (with the alert and context features represented in numerical/binary form as vector elements) and is repeated for all alerts in the group. The encoded alert data is then formed into a time-ordered encoded alert sequence for input to the machine learning model in step 408.

FIG. 7 illustrates the machine learning model in more detail.

As described above, the input to the neural network is a time series of context-enhanced alert records. Multiple such inputs are created for a <user, device> pairing based on a sliding window. Successive windows may be overlapping or non-overlapping.

More specifically, the machine learning model receives as input a sequence of enhanced alert records 702, each associated with an alert time and including a set of alert features and context features such as user, device, service and authorisation features. The alert records are encoded in a vectorized representation as described above, resulting in an input of size M×N where N is the number of alerts in the sequence and M is the number of features. If required, the system may define a maximum number of alerts and zero-pad the input data set if the number of alerts in the input sequence is less than the maximum to provide a consistent input size.

Enhanced, vectorized alert records from the input sequence are input to the model one-by-one. The model 700 is a recurrent neural network that captures temporal relationships between alerts in a sequence by implementing feedback in the network.

The model provides an embedding layer 704 as a pre-processing stage. The embedding layer implements dimensionality reduction by generating an embedding of the M-element input vector (corresponding to a context-enhanced alert record) in a vector space with a reduced number P of dimensions, resulting in a reduced P-element vector. In some examples, the embedding step may reduce the input size by a factor of around 10 (e.g. reducing a 10000-bit input vector to a 1000-bit vector).

The output of the embedding layer is provided to a layer of LSTM (long short-term memory) neurons, which implement feedback to allow the model to capture relationships between alerts in a sequence. The output of that layer is processed by an average pooling layer (708), for the purpose of pooling and reducing dimensionality to the needed output size. This is followed by a sigmoid layer (710) to scale the output to a 0 . . . 1 range. That scaled output provides the final model output, in the form of the anomaly score (712). The anomaly score defines numerically whether the sequence of alerts forming the model input represents anomalous or normal behaviour (e.g. a low score may indicate normal behaviour and a high score may indicate anomalous behaviour).

Instead of processing alerts by the model one at a time, a wider neural network may be provided which processes the sequence of alerts of a given window in parallel. In that case, the N alerts in the sequence are concatenated to form a single wide M×N input vector, which may be zero-padded as needed. The model then processes the wide input vector representing the event sequence for the window in a single pass (with the embedding stage operating on the M×N input vector).

The output of the model may be processed further as needed, e.g. to rescale to an arbitrary scale (e.g. 0-10). The severity of the anomaly is based on how close the output is to the maximum.

The system could additionally or alternatively assign a severity classification (e.g. low/medium/high) and/or compare the output to various thresholds or ranges as described in more detail below.

Further details of LSTM-based models can be found in Hochreiter, Sepp, and Jurgen Schmidhuber. “Long short-term memory.” Neural computation 9.8 (1997): 1735-1780. While a specific neural network architecture is shown, other neural network architectures or indeed other types of machine learning models may be used (such as support vector machines, decision tree models, random forests etc.)

Note that in this example the embedding layer is part of the machine learning model and is trained during model training. However, in other examples a separate embedding/dimensionality reduction pre-processing step could be performed prior to inputting data to the model (in which case such an embedding could be learnt separately from the training of the model itself).

Also illustrated in FIG. 7 is an anomaly label 714. This defines the anomaly score assigned to a training sample during training of the model 700 but is not used during application of the model to unseen input data.

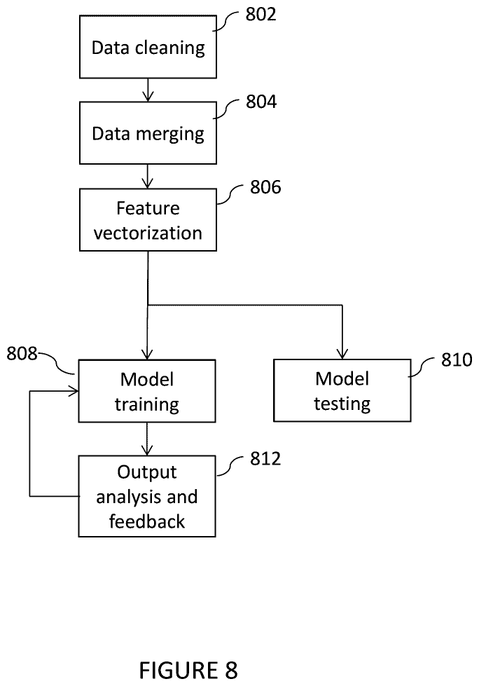

FIG. 8 illustrates a model training process for training the machine learning model on a set of input alert data.

The model is trained based on a set of training samples. The training samples are created from raw alert data using a process similar to that described above for application of the trained model. However, if required, in pre-processing step 802, data cleaning may first be performed.

This may involve the following steps to clean the raw alert data:
Data sanitization—removing data that does not comply with the data type specification
Data imputation—imputing missing data based on associated columns (e.g. based on predetermined rules or trained ML models for imputing missing data values)

In step 804, data merging is then performed to merge the data from the context tables with the security alerts to create context-enhanced alert records, as described in relation to FIG. 2 and feature vectorization is performed for resulting alert records as previously described (step 806). The resulting vectorized alert records comprise concatenated numerical representations of the input features (alert and context features).

Model training is then performed in step 808 on the context-enhanced, vectorized alert records. To enable learning, ground truth anomaly labels (corresponding to the anomaly scores output by the model) are associated with the training data. Standard training algorithms for LSTM models (such as gradient descent combined with backpropagation through time) may be used.

Anomaly labels for the training data may be provided by an expert operator based on inspecting and analysing the source alert data and context data and then assigning an appropriate anomaly label (e.g. as an integer on a predefined scale).

In preferred embodiments, an approach referred to as “active learning” is used to train the model. For details see e.g. Settles, Burr. “Active learning literature survey.” (2009).

In this approach, the training, validation and test data can be:
1) Labelled—alerts have a label giving an anomaly score or ranking that indicates whether they indicate a cybersecurity incident
2) Unlabelled—alerts that do not have any ground truth label

The model is constructed to use partially labelled data and to make use of expert feedback through the interaction of a human expert with a visualization interface to view and analyse model outputs (step 812). This interaction enables the labelling or relabeling of security alert data and initiation of model retraining. Training is performed on training and validation data sets of security alert data.

To expand the available training data, labels can be propagated from the labelled data to unlabelled data using label propagation techniques (see e.g. X. Zhu et al., “Learning from Labels and Unlabeled Data with Label Propagation”, available online at http://reports-archive.adm.cs.cmu.edu/anon/cald/CMU-CALD-02-107.pdf). In this approach, unlabelled examples are given a label based on the labelled points that are closest to the unlabelled examples (e.g. using a distance metric in the feature space of the alert vectors). Because an active learning process is used, the resulting model outputs can be reviewed by the analyst and relabeled as needed, in which case the relabeled data is added to the training set and used as a labelled training example in the retraining process.

Active learning is achieved by displaying labelling tasks to the analyst/operator for labelling. The labelling tasks are chosen from a test set of unlabelled data based on:
Uncertainty of the model—training samples corresponding to points chosen based on a threshold on how close to 0-1 the anomaly score output by the model is (e.g. this could be points in the model input feature space where the model outputs anomaly scores in an uncertainty range, e.g. 0.4-0.6)
Diversity of labelled points—training samples corresponding to points falling within a region of the input feature space where there are not enough labelled samples (e.g. that are sparsely populated by labelled training samples, which could be determined based on a density measure)
Detected mistakes—when anomaly scores output by the model are detected to be wrong/relabelled by the analyst.

Once a model has been trained, its performance can be evaluated in a model testing step 810 on a separate test data set. The model is tested or queried by submitting test data to the existing model and retrieving outputs (anomaly scores), which can be compared to previously recorded ground truth labels or to labels provided by an expert through interactive feedback.

In the above example, the neural network essentially implements a regression model, providing a numerical anomaly score. In alternative embodiments, a classification model could instead be implemented. This could be a binary classification (e.g. risk/no risk), or a multiclass classification, where the model would classify the time window in multiple classes of attack or as a benign example. In that case the model could be adapted to use a softmax layer instead of the sigmoid layer.

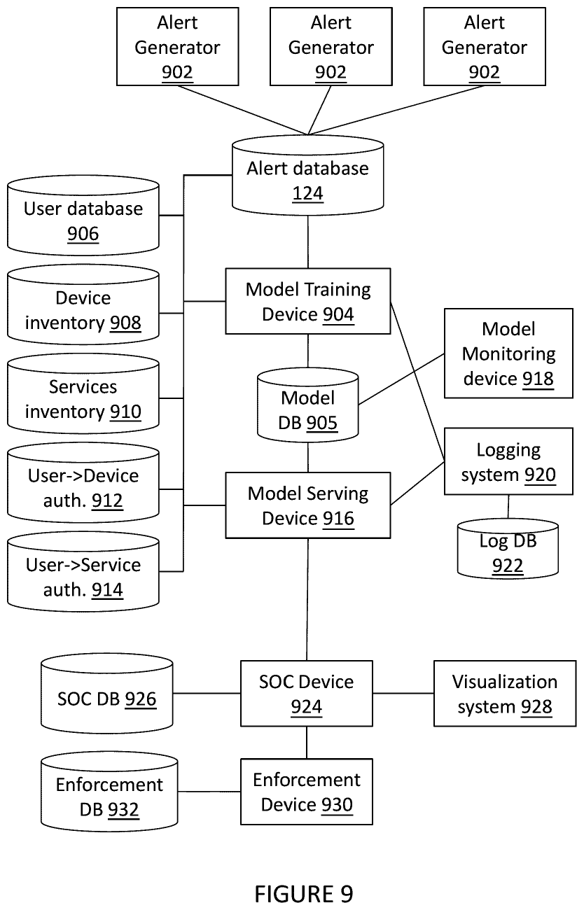

FIG. 9 provides a more detailed example of a system architecture for implementing described techniques. In this implementation, models are trained by a model training device 904 based on alert data obtained from a set of alert generators 902 and stored in alert database 124, and context data from context databases 906-914. Alert generators can include any device or software entity that acts as a source of alerts to the alert database (such as firewalls and other network security devices). The context databases may include a user database 906, device inventory 908, service inventory 910, user/device authorisation database 912 and user/service authorisation database 914, as discussed previously.

Trained models are stored in model database 905 (stored model data includes, for example, the trained sets of input weights for neurons of the neural network, hyperparameters etc). Various different trained models may be maintained in the model database at the same time (e.g. trained on different training/validation sets or with different model hyperparameters). Models may be monitored by a model monitoring device 918, e.g. by testing models against test data and determining model performance metrics. Models may be periodically retrained, and available test data may change over time as new alerts are processed, labelled or relabelled by operators. The model training device may thus test models periodically and store and update performance data in the database specifying the performance of stored models, allowing better models to be selected and/or models that are no longer considered effective to be removed. The model training device may measure and track any suitable performance metrics, e.g. by measuring a loss function when a model is trained/retrained, tracking model classification errors (e.g. when anomalies are manually reclassified by an analyst) etc.

Trained models may be applied to new alert data by model service device 916. In an embodiment, the model serving device is invoked for a specific input data set of alert data from alert database 124 and a specified trained model stored in the model database. The model serving device retrieves the specified model and applies it to the input data as described in relation to FIG. 2. The model training device, model serving device, and model monitoring device (together with the model database) together are also referred to as the model management subsystem.

A logging system 920 and logging database 922 is provided to log activities of the model training device 904 and model serving device 916.

The model servicing device is invoked by a Security Operation Centre (SOC) device 924, which stores model results and other relevant data in an SOC database 926. The model results can be displayed to a user by a visualisation system 928. The visualisation system provides an application front end (e.g. as a web application) for displaying source alert data, context-enhanced alerts and model results (processed alerts including anomaly scores assigned by the model) to an operator and receiving user feedback, for example to relabel alert data (where the expert considers the anomaly score output by the model to be inaccurate) and/or initiate retraining of the model.

Model outputs obtained by the SOC device may also be used to provide enforcement information to an enforcement device 930. For example, the SOC device may send commands to the enforcement device to perform enforcement actions, such as reconfiguring network devices, to address identified security risks, as described in more detail later. An enforcement database 932 stores information used by the enforcement device, for example detailing configurable security devices in the network, enforcement actions performed etc. Other external systems could also be interfaced to the SOC and/or enforcement devices to utilise model outputs, such as a network flow processing device, threat intelligence database etc.

While system components are referred to above as embodied in various “devices”, these may or may not be distinct physical processing devices. Any of the depicted components may be provided as separate physical processing devices or as software modules/services implemented on one or more (shared) physical devices. For example, the model training, model serving and model monitoring devices could be implemented in a single model management server.

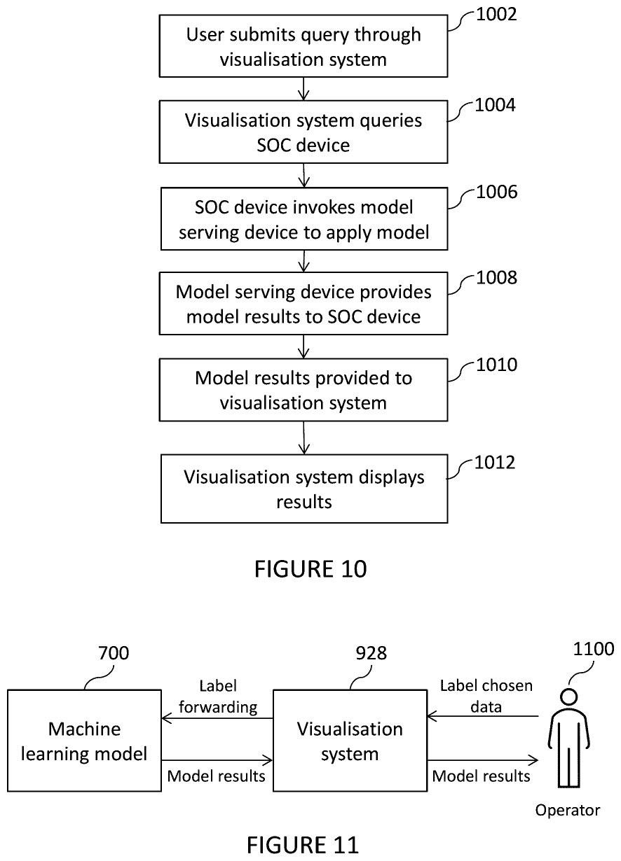

A typical workflow utilising the above system is shown in FIG. 10 and begins with a user submitting a query to process alert data through the visualisation system in step 1002. The visualisation system queries the SOC device in step 1004 to process the alert data. In step 1006, the SOC device invokes the model serving device to apply a specified model from the model database to the alert data (or more specifically, to context-enhanced alert groups derived from the alert data as explained in relation to FIG. 2). The model serving device applies the model to generate the anomaly scores for alert groups and the model outputs are sent by the model serving device to the SOC device in step 1008. In step 1010, the SOC device returns the model results to the visualisation system, which displays the results to the user in step 1012.

Operator feedback may be used for progressive refinement of the machine learning model using the active learning approach. This is illustrated in FIG. 11. The model serving device provides results of applying a particular machine learning model 700 to a data set to the visualisation system 928, which outputs the results to an operator 1100. The operator evaluates the results and can choose to relabel some results to indicate that the anomaly score assigned by the model was considered incorrect and provide a corrected score. The operator may also label previously unlabelled data. The visualisation system forwards the updated labels to the machine learning system where it is used to retrain the model 700, resulting in an improved model.

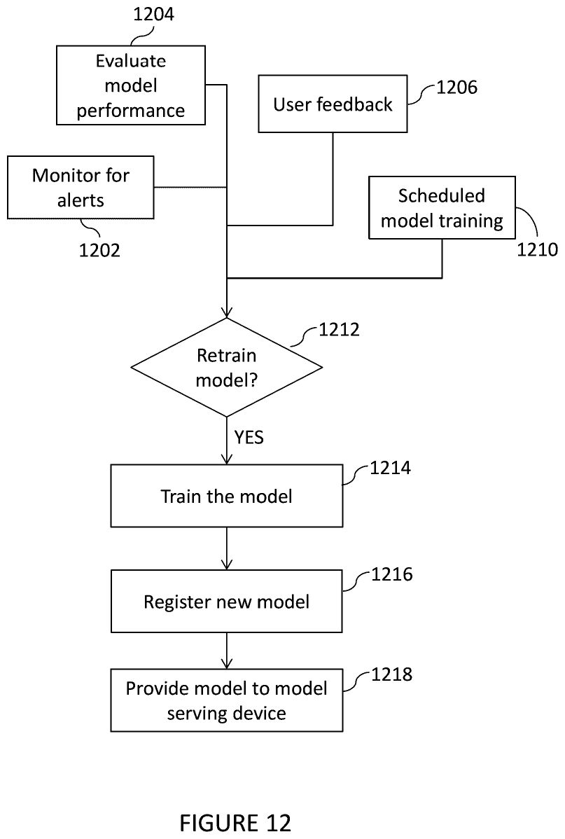

The machine learning model(s) may be retrained based on various triggers and criteria, including based on receipt of new alerts, evaluation of model performance, user feedback and a retraining schedule. This is illustrated in FIG. 12.

In step 1202 one or more alerts are generated in the network (by any of the alert generator sources). In step 1212, the system determines based on predefined criteria whether the alert necessitates retraining of the model to include the new alert. This could be based, for example on the alert type or severity. Criteria could also be based on multiple alerts, for example, to trigger retraining when a certain number of alerts have been received since the last time the model was retrained (or a certain number of alerts of a predetermined type). If the criteria are fulfilled, the process proceeds to retrain the model in step 1214.

As a further trigger, retraining may be initiated in response to evaluation of the model performance in step 1204 (e.g. performed by model monitoring device 918). Various performance metrics may be computed such as accuracy, precision, recall, F1 score etc. If the performance of the model according to calculated metrics falls under a defined threshold, retraining is initiated.

Retraining may also be initiated based on user feedback (step 1206). The feedback may include a user labelling new alert data or relabeling previously labelled alert records and/or explicitly requesting that the model be retrained.

Additionally, retraining can be initiated based on a model training schedule in step 1210. For example, the schedule may specify that the model should be retrained every n days.

Retraining is performed in step 1214. The model may be retrained to include alerts that occurred in a specific time interval (e.g. the most recent m days of alert data). In step 1216, the newly trained model is registered and stored in the model database and can then be provided to the model serving device in step 1218 for use in queries by the SOC device. The new model may replace an existing model or may be stored alongside existing model(s).

Retraining the model regularly based on various triggers can allow the model to adapt to the changing environment and changing alert profile over time and improve overall accuracy of the model.

FIG. 9 depicts the model training and model serving devices obtaining data directly from various databases 124, 906-914. It should be noted that the term “database” is used herein in a general sense to refer to any source or collection of data. In practice the depicted databases may be combined into fewer databases or even a single database. For example, the data of the various depicted databases may be stored in separate tables of a relational database. In a typical embodiment, the data may be obtained from external sources. For example, context data such as user, service, device and authorisation data may be imported into a database from one or more external sources. The data may then be combined as described to create context-enhanced alert records, and the resulting records are vectorised by converting attributes in a format suitable for input to the neural network. In that case, the vectorization may be performed as a pre-processing step (e.g. between steps 204 and 206 in FIG. 2), with the machine learning model then operating on the vectorized records in steps 206-222 (rather than performing the vectorization immediately prior to input to the machine learning model as shown in step 210 of FIG. 2).

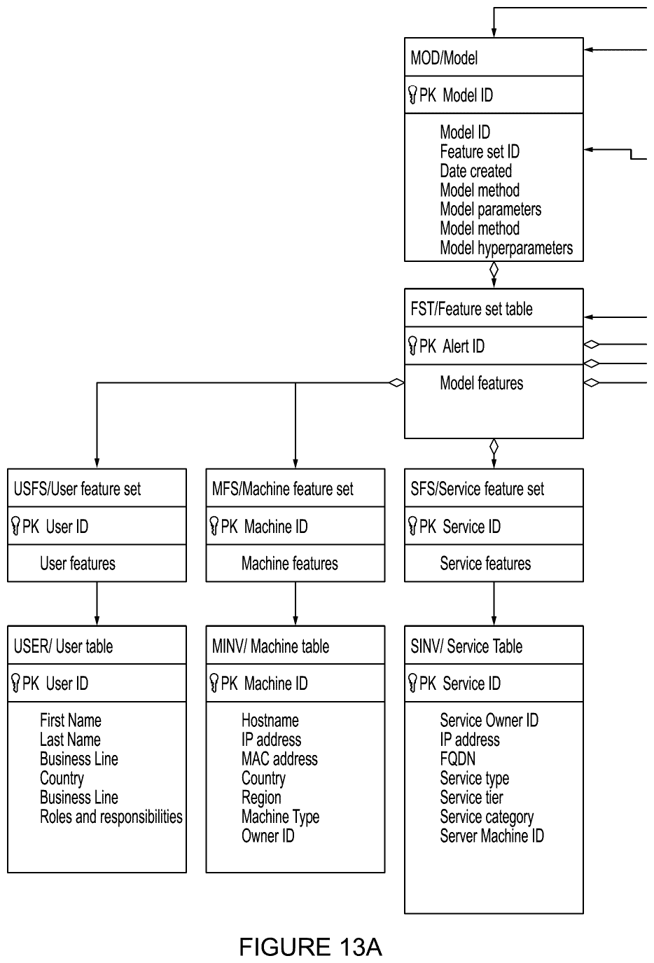

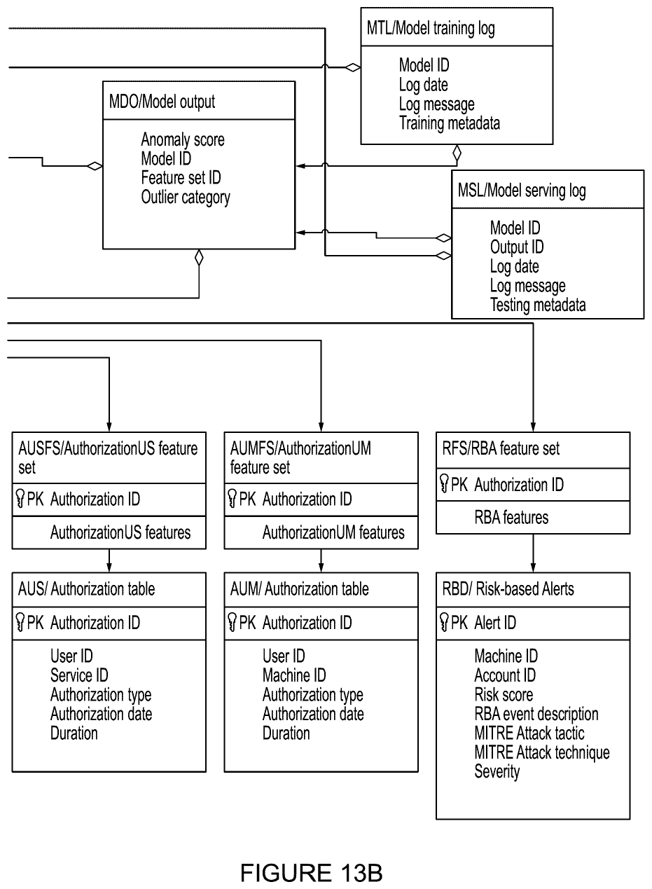

An example data model for a combined database is shown in FIGS. 13A-13B (in which “machine” refers to a “device” as used elsewhere herein). A set of source tables are shown at the bottom tier of the data model, including the various context tables and alert table of FIGS. 5A-5F. The associated feature tables store the numerical feature values that are used in the model, i.e. data from the raw tables transformed into numerical form as previously described. The feature set table contains all features that are used as inputs in the model, i.e. a concatenation of features from the other feature tables (user, machine etc.), together with the alert features. The model table stores trained models, including the feature set on which the model was trained and the model parameters and hyperparameters. Model outputs are stored in the model output table, and logging data is stored in the logging tables.

Returning to FIG. 9, the visualisation system 928 provides an application with functionality for visualising alert data and results of the machine learning model and interacting with the system. In an embodiment, the application provides a dashboard-type interface. The dashboard gives an overview of alerts (e.g. as a list, which may be ranked by anomaly score). An alert table provides a detailed tabular description of the alert and the context, including, for example:
Alert properties
Account context (user or service account)
Device context
Related alerts
Related SOC investigations

The dashboard and the tabular description provide options for user feedback, in case of detected false positives or inadequate classification or ranking. This feedback is taken into account in the retraining of the model as described previously. In particular, the user can relabel selected groups of alerts. The choice of data to relabel can be based on:
Classification or ranking mistakes detected independently by the expert using the system
Areas of uncertainty—the model is able to find the data where the classification or ranking is uncertain, or where there is not enough labelled data and prompt the user to label or relabel this data.

The alert table may list any desired alert attributes and features of alerts, such as the user/account identifier, device, MITRE attack technique etc. Relevant data from the context attributes may also be displayed.

Additionally, the dashboard may display visualisations such as alert maps (e.g. plotted on selected alert feature dimensions and colour coded based on anomaly score), as well as charts or histograms of alert frequencies or counts for different alert types, anomaly score bands etc. The user interface may also provide menu options for interacting with the system, for example, to suppress selected alerts, trigger remediation actions and/or retrain the model.

As explained in relation to FIG. 2 (step 216, 222), after an anomaly score has been calculated for an alert group, one or more actions may be performed. Actions may include alerting an operator to an anomaly and/or automatic action by enforcement device 930 (FIG. 9) to implement remediation/countermeasures in the network.

In one approach, multiple thresholds are considered on the anomaly score. If the anomaly score a is over a predefined automatic action threshold (a>tₐ), automatic action is triggered to quarantine a device or disable an account linked to this group of alerts. If the anomaly score is over a lower threshold (tₘ<a≤tₐ) the event is displayed to the analyst for manual action. If the anomaly score does not exceed the lower threshold (a≤tₘ) the alert group may be considered not anomalous/not indicating a security risk and so no action may be taken.

Additional thresholds may be applied to identify alert groups for which the anomaly score output is considered uncertain. In this approach, if the output is between two thresholds of certainty (tₗ<a<tₕ<tₐ) the event is displayed/flagged to the operator for the operator (if appropriate) to manually label the alert group, using the active learning approach described above.

Actions performed in step 222 (e.g. by enforcement device 930) may serve to enforce restriction of network traffic or allowed user or device activity. For example, automatic actions could include:
Quarantining a device (e.g. configuring the network to isolate/drop traffic from or to the device)
Changing network traffic rules to impede the behaviour giving rise to the alerts (e.g. modifying firewall rules to drop packets, modifying load balancer rules or quality-of-service rules to block, throttle or otherwise shape traffic associated with the behaviour);
Locking one or more user accounts of a user associated with the alerts (e.g. temporarily or permanently restricting or withdrawing access rights)
Configuring enhanced security monitoring (e.g. configuring packet sniffers to reroute/copy packets associated with anomalous behaviour, perform deep packet inspection etc.)

The same actions may be provided for selection by an operator in the system interface to allow manual action to be triggered by the operator after inspecting the alerts and anomaly scores assigned by the model. Whether triggered automatically or manually, the actions are carried out by the enforcement device 930, which interfaces with various network devices, such as routers, firewalls etc. to implement configuration changes in the network.

The described embodiments can thus provide a system for detection and ranking of anomalous activity, based on iterative learning of machine learning models, which can provide a variety of advantages, such as:
Acceleration of incident detection, alert processing and analysis
More accurate and up-to-date model of normal and anomalous behaviour
Faster resolution of alerts and incidents within the system through enhanced contextual information
More accurate ranking, classification and anomaly detection
Faster analysis of cybersecurity alerts and faster cybersecurity investigation
More automation in cybersecurity incident analysis

Whilst the described system performs anomaly detection based on the use of a machine learning model, embodiments may combine this with other approaches, such as rule-based anomaly detection. For example, a rule-based anomaly detection system may process alerts using a manually designed rule set to detect anomalies. The system may then output anomalies identified by either the rule-based or the machine-learning based subsystem to the user and/or may combine the outputs (e.g. by identifying rule-based anomaly detections using a distinct anomaly classification or flagging anomalies detected by both subsystems as more severe).

### Example Computer System

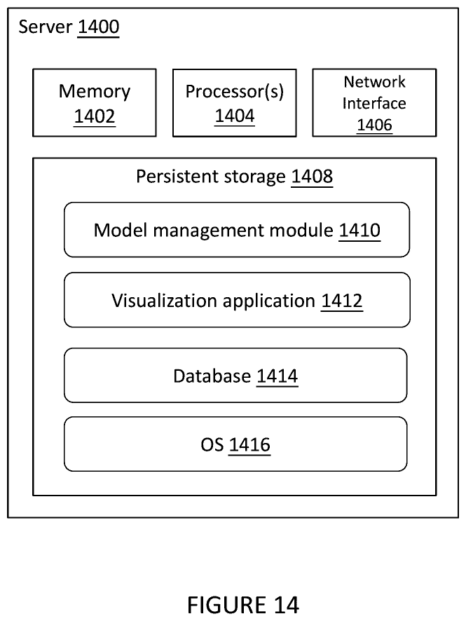

FIG. 14 illustrates an example of a server 1400 that may be used to implement described techniques and processes. In particular, the depicted server may be used to implement the alert processor 130 of FIG. 1 and/or various components of FIG. 9.

The server 1400 includes one or more processors 1404 together with volatile/random access memory 1402 for storing temporary data and software code being executed.

A network interface 1406 is provided for communication with other system components (such as the monitored network infrastructure 110 and associated alert generators 902, data collection system 122, inventory management system 126 or other data sources/external databases) over one or more networks (e.g. Local and/or Wide Area Networks, including the Internet).

Persistent storage 1408 (e.g. in the form of hard disk storage, optical storage and the like) persistently stores software and data for performing various described functions. For example, this may include a model management module 1410 implementing functions of the model training device 904 and model service device 916 of FIG. 9 and a visualization application backend 1412 for visualising alert data, model results and allowing user feedback and interaction. The persistent storage also includes a database 1414 (e.g. implemented using a known database management system) for storing the alert data, context data, and model data. The persistent storage further includes a server operating system 1416 and any other software and data needed for operating the server. The server will include other conventional hardware components as known to those skilled in the art, and the components are interconnected by one or more data buses (e.g. a memory bus and I/O bus).

While a specific architecture is shown and described by way of example, any appropriate hardware/software architecture may be employed to implement the inventory system.

Furthermore, functional components indicated as separate may be combined and vice versa. For example, the various functions may be performed by a single server 1400 or may be distributed across multiple servers. As a concrete example, one or more databases could be stored at a separate database server. Separate servers could also be implemented to provide model management functions and the visualisation application. The visualisation application 1412 may be a web application and thus may be implemented server-side by a web server providing back-end components for the application, with front-end components served for execution by client device 136 (FIG. 1)/SOC device 924. The client device may be a standard user device such as personal desktop or laptop computer, tablet computer, smartphone or other mobile device, running a web browser for accessing the web application (or alternatively running a bespoke local application).

It will be understood that the present invention has been described above purely by way of example, and modification of detail can be made within the scope of the invention.

1. A computer-implemented method of processing network security alerts, comprising:
receiving a plurality of security alerts generated by network security devices in a network, each security alert comprising alert data relating to the security alert, the alert data specifying an alert time and one or both of: a network device and a user identity associated with the security alert;
selecting from the plurality of security alerts a group of related alerts, the group of related alerts having an alert time within a given time window and associated with one or both of: a given network device; and a given user identity;
generating, based on alert data of the selected alerts, an input data set for a machine learning model, the machine learning model configured to generate an anomaly score in dependence on the input data set;
inputting the input data set to the machine learning model to obtain the anomaly score for the input data set; and
performing an action in dependence on the anomaly score, wherein the action is configured to control network traffic.

2. A method according to claim 1, comprising generating a plurality of alert groups associated with the given network device and/or given user identity based on respective time windows and applying the machine learning model to input data sets generated for each alert group.

3. (canceled)

4. A method according to claim 1, wherein the input data set comprises a sequence of alert records corresponding to a sequence of security alerts having alert times within the given time window and associated with the given network device and/or the given user identity.

5. (canceled)

6. A method according to claim 4, comprising, for one or more of the security alerts in the group of alerts, obtaining context data relating to each alert from one or more context data sources and adding the context data to the corresponding alert record, wherein the context data sources optionally comprise one or more of: user data, device data, software service data, and user authorisation data.

7. (canceled)

8. A method according to claim 6, wherein security alerts are associated with network events detected in the network, and wherein the context data for a security alert associated with a given network event comprises data relating to one or more of:
a user identity associated with the event;
a network device involved in the event;
a software service or application involved in the event;
a user authorisation of a user associated with the event, the user authorization comprising one or more of: a service authorisation and a device authorisation associated with the event.

9. A method according to claim 4, the method comprising converting alert records including alert attributes and/or context attributes into a numerical input representation for input to the machine learning model, the conversion optionally comprising one or both of:
normalising one or more numerical attributes to a predetermined range, optionally a range of zero to one; and/or
encoding one or more categorical attributes using a binary encoding, optionally a one-hot encoding.

10. A method according to claim 6, the method comprising:
identifying, for a given security alert, a network device to which the security alert relates, wherein a network device is a network device at which a network event or operation that caused the security alert occurred or was performed;
retrieving from a context data source device data relating to the identified network device;
generating one or more device context attributes based on the device data; and
including the one or more device context attributes in the alert record for the security alert.

11. A method according to claim 6, the method comprising:
identifying, for a given security alert, a software service to which the security alert relates, wherein the software service is preferably a software service at which an event or operation that caused the security alert occurred or was performed;
retrieving from a context data source software service data relating to the identified network device;
generating one or more software service context attributes based on the software service data; and
including the one or more software service context attributes in the alert record for the security alert.

12. A method according to claim 6, the method comprising:
identifying, for a given security alert, a user identity of a user to which the security alert relates;
retrieving from a context data source user data relating to the identified user identity;
generating one or more user context attributes based on the user data; and
including the one or more user context attributes in the alert record for the security alert.

13. A method according to claim 6, the method comprising:
identifying, for a given security alert, a user identity of a user to which the security alert relates;
retrieving from a context data source authorisation data relating to the identified user identity;
generating one or more authorisation context attributes based on the authorisation data; and
including the one or more authorisation context attributes in the alert record for the security alert.

14-17. (canceled)

18. A method according to claim 1, wherein the machine learning model comprises a recurrent neural network (RNN) adapted to process alert records for the group of alerts in sequence and to generate and output an anomaly score based on the alert records of the group.

19. A method according to claim 18, the machine learning model comprising a long short term memory (LSTM) based network having an embedding layer adapted to perform dimensionality reduction for alert records comprising a plurality of alert and/or context attributes, and an LSTM layer adapted to operate on the output of the embedding layer.

20. A method according to claim 19, the machine learning model further comprising one or more further layers for generating the anomaly score based on the output of the LSTM layer, the further layers optionally including an average pooling layer and/or a scaling layer adapted to scale an output of the model to a predetermined range, the scaling layer optionally comprising a sigmoid layer.

21. A method according to claim 1, comprising training the machine learning model based on a training data set, the training data set comprising groups of security alerts augmented with context data and associated with training labels, wherein training labels define an expected anomaly score output of the model and are obtained based on one or more of: user labelling of training samples; and label propagation from previously labelled training samples.

22. (canceled)

23. A method according to claim 21, the method comprising retraining the model in dependence on one or more retraining trigger conditions, the retraining trigger conditions comprising one or more of:
reception of one or more security alerts;
one or more performance metrics relating to performance of the model;
user feedback, optionally to relabel one or more alert groups;
a retraining schedule.

24. (canceled)

25. (canceled)

26. A method according to claim 1, the method comprising identifying one or more training samples for labelling by an operator, receiving via an application interface training labels for the training samples from the operator, and using the training samples and training labels to train or retrain the machine learning model, and wherein identifying one or more training samples comprises identifying one or more of:
one or more training samples in a region of the machine learning model input feature space associated with model outputs that fall in a predetermined uncertainty range;
one or more training samples in a region of the input feature space that is sparsely populated with labelled training samples;
one or more training samples relabeled by the operator via the application interface.

27. (canceled)

28. A method according to claim 1, the method comprising comparing the anomaly score to one or more thresholds or ranges, and selecting the action in dependence on the comparison.

29. A method according to claim 28, the method comprising:
in response to the anomaly score meeting a first threshold or falling in a first range, alerting a user; and
in response to the anomaly score meeting a second threshold or falling in a second range, performing an automatic configuration action in the network to counter a security risk associated with the group of alerts.

30. A method according to claim 28, the method comprising, in response to the anomaly score output by the model falling within a determined range, prompting a user to review the alerts of the alert group and assign an anomaly score.

31. A method according to claim 1, wherein the controlling network traffic comprises one or more of:
modifying a configuration of, disabling, or quarantining a device associated with the group of security alerts;
modifying a security device configuration in the network to control, shape or block traffic associated with a user, device or software service to which security alerts of the group relate;
modifying one or more user authorisations to disable a user account or user access to a device or software service.

32. (canceled)

33. (canceled)
